(19) United States
(12) Patent Application Publication
(10) Pub. No.: US 2004/0189884 A1
(43) Pub. Date: Sep. 30, 2004

(54) Liquid crystal display

(76) Inventors: Cheon Hong Kim, Seoul (KR); Seong Jun Ahn, Kyoungki-do (KR); Se Jong Yoo, Kyoungki-do (KR)

Correspondence Address: LADAS & PARRY, 224 SOUTH MICHIGAN AVENUE, SUITE 1200, CHICAGO, IL, 60604, US

(21) Appl. No.: 10/656,576

(22) Filed: Sep. 5, 2003

(30) Foreign Application Priority Data
Mar. 31, 2003 (KR) 2003-19950

(51) Int. Cl. G02F 1/1343

(52) U.S. Cl. 349/38

(57) ABSTRACT

Disclosed is a liquid crystal display in which a kick-back voltage of pixels used in the liquid crystal display. The liquid crystal display comprises thin film transistors connected to intersections between a plurality of data lines and a plurality of gate lines; pixel electrodes, each of which is connected to a source of each of the thin film transistors; common electrodes opposed to the pixel electrodes; liquid crystal injected between the pixel electrodes and the common electrodes; a plurality of auxiliary gate lines corresponding to the gate lines; and first capacitors, each of which is connected between the source and each of the auxiliary gate lines. By this construction, even if the voltage of a gate line goes down rapidly, it is possible to minimize variation width of a pixel voltage in the liquid crystal display. Therefore, as compared to the prior art, the liquid crystal display has advantages in that a dynamic range of data line voltage is lower, the adjustment of the common voltage Vcom is unnecessary, a display problem of 30Hz flicker caused by the kick-back voltage ΔVp can be solved, and so forth.

### BACKGROUND OF THE INVENTION

1. Field of the Invention

The present invention relates to a liquid crystal display, and more particularly to a liquid crystal display in which a kick-back voltage of each pixel used in an active matrix LCD (Liquid Crystal Display) is improved.

2. Description of the Prior Art

In general, a structure of each pixel in a TFT-LCD (Thin Film Transistor Liquid Crystal Display) comprises one TFT of an amorphous silicon TFT and a polycrystalline silicon TFT, a storage capacitor, and a pixel electrode for applying a voltage to liquid crystal. FIG. 1 is a view showing a pixel structure of in a general TFT-LCD according to the prior art. Because the pixel structure shown in FIG. 1 is a standard structure, more description about the pixel structure will be omitted, while a waveform view related to an operation thereof is illustrated in FIG. 2.

As shown in FIG. 2, in the case of using a conventional pixel structure, a voltage of node P—that is, a voltage related to charge stored in the storage capacitor—is down as much as ΔVp (kick-back voltage) at the moment that a voltage of a gage line is transformed to a low state. This is because as a voltage of a gate line is rapidly decreased, a voltage of node P (a voltage of a pixel) is also down due to a coupling phenomenon caused by a parasitic capacitance Cgs between a gate electrode and a source electrode of a TFT (Thin Film Transistor). Due to this reason, a voltage dropped by ΔVp as compared to a voltage of a data line is applied to liquid crystal. The kick-back voltage ΔVp is generally expressed as equation 1 as follows.

Equation 1

ΔVp=Cgs/(Clc+Cst+Cgs)×(Vglow−Vghigh)

Herein, a reference character ‘Clc’ designates a capacitance of the liquid crystal, a reference character ‘Cgs’ designates a parasitic capacitance between a source and a gate, and reference characters ‘Vglow’ and ‘Vghigh’ designate a low voltage and a high voltage respectively applied to a gate line.

As shown in the equation 1, the kick-back voltage ΔVp decreases a voltage of the liquid crystal, while being changed in the same direction as that of a variation of a gate voltage of a TFT. Also, since the liquid crystal capacitance Clc and the parasitic capacitance Cgs are changed according to an applied voltage, the kick-back voltage ΔVp may appear as various different values according to gradation, and thus correspondingly different common voltages for each different gradation are required. Therefore, a pixel structure capable of minimizing the kick-back voltage ΔVp is required.

### SUMMARY OF THE INVENTION

Accordingly, the present invention has been made to solve the above-mentioned problems occurring in the prior art, and an object of the present invention is to provide a liquid crystal display having a pixel structure without kick-back voltage.

To this end, in the present invention, proposed is a liquid crystal display capable of compensating for a kick-back voltage ΔVp caused by a rapid change of a gate line signal by additionally constructing another gate signal line having an opposite polarity with respect to a gate line signal of each pixel.

In order to accomplish this object, there is provided a liquid crystal display comprising: thin film transistors connected to intersections between a plurality of data lines and a plurality of gate lines; pixel electrodes, each of which is connected to a source of each of the thin film transistors; common electrodes opposed to the pixel electrodes; liquid crystal injected between the pixel electrodes and the common electrodes; a plurality of auxiliary gate lines corresponding to the gate lines; and first capacitors, each of which is connected between the source and each of the auxiliary gate lines.

In the present invention, a second capacitor is connected between the source and each of the common electrodes.

Also, in the present invention, the polarity of the voltage applied to the auxiliary gate line is opposite to that applied to the gate line.

Also, in the present invention, the first capacitor has capacitance identical to that of a parasitic capacitance between the source and gate of the thin film transistor.

### BRIEF DESCRIPTION OF THE DRAWINGS

The above and other objects, features and advantages of the present invention will be more apparent from the following detailed description taken in conjunction with the accompanying drawings, in which:

FIG. 1 is a view showing a pixel structure of a general TFT-LCD according to the prior art;

FIG. 2 is a waveform view showing operation of FIG. 1;

FIG. 3 is a view showing an embodiment of a pixel structure according to the prevent invention;

FIG. 4 is a waveform view showing operation of FIG. 3; and

FIG. 5 is a view showing another embodiment of a pixel structure according to the prevent invention.

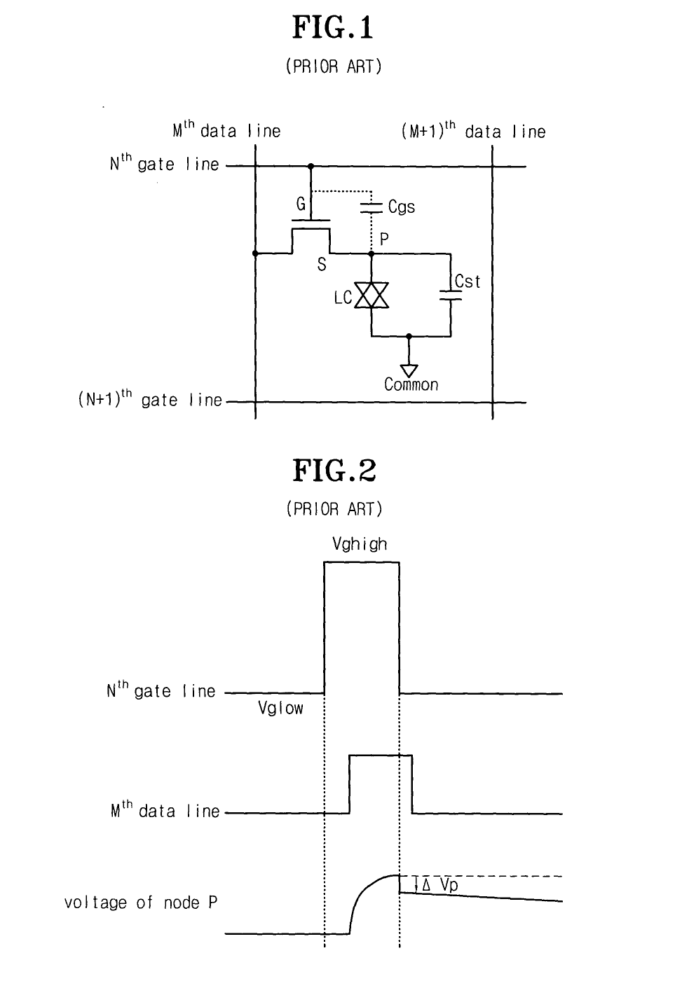

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description for the same or similar components will be omitted.

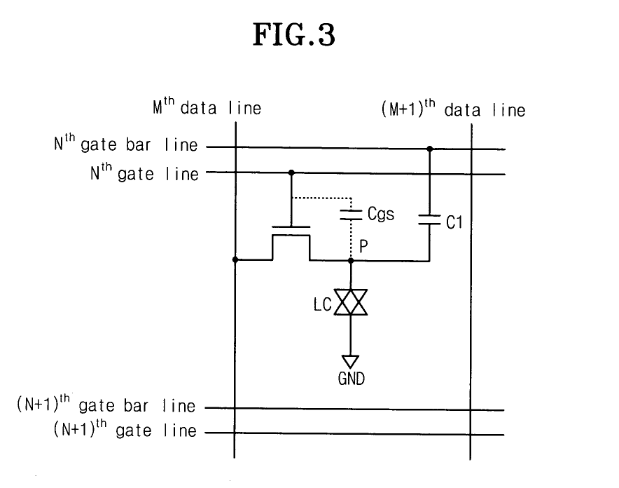

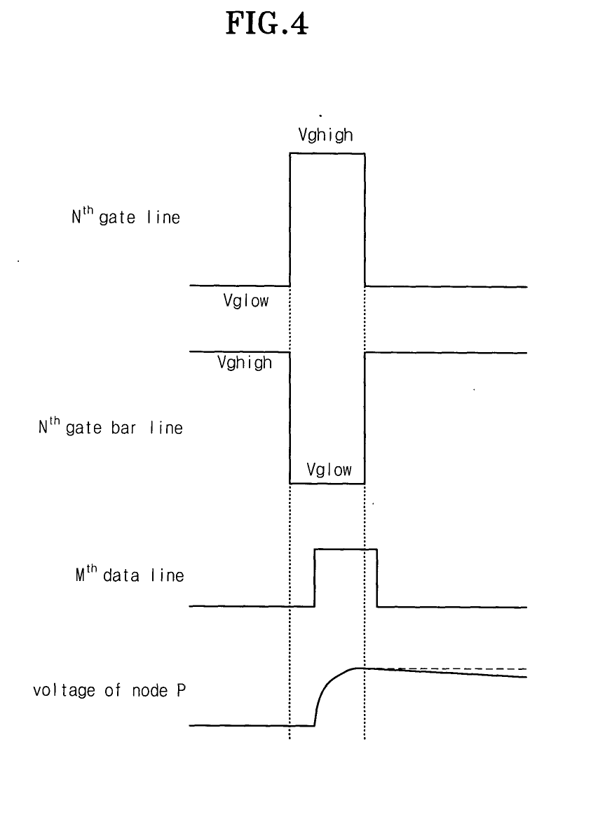

FIG. 3 is a view showing an embodiment of a pixel structure according to the prevent invention, and FIG. 4 is a waveform view showing operation of FIG. 3.

According to an embodiment shown in FIG. 3, a liquid crystal display includes not only a plurality of first gate lines (including an N^{th} gate line and an (N+1)^{th} gate line) and a plurality of data lines (including an M^{th} data line and an (M+1)^{th} data line) perpendicularly intersecting each other, but also a plurality of second gate lines (auxiliary gate lines, including an N^{th} gate bar line and an (N+1)^{th} gate bar line) corresponding to the first gate lines, respectively. Also, liquid crystal is connected between ground and the source of a TFT, in which the gate of the TFT is connected to a first gate line and the drain of the TFT is connected to a corresponding data line, and a first capacitor C1 is connected between the source and a second gate line.

As shown in FIG. 3, one gate line and one data line are connected to a TFT for each pixel, and one capacitor C1 is connected between one gate bar line and node P (pixel electrode). Herein, a signal of an opposite polarity with respect to a signal of a corresponding gate line is applied to the gate bar line (see FIG. 4) . In an embodiment of the present invention, it is preferred that the capacitor C1 is constructed so as to have the same capacitance as the parasitic capacitance Cgs between the source and the gate of the TFT.

In the case of a pixel structure shown in FIG. 3, it is possible to compensate for a kick-back voltage caused by the effect of a parasitic capacitance Cgs with the capacitor C1, and the equation of the kick-back voltage ΔVp of the case is represented as follows.

Equation 2

ΔVp=Cgs/(Clc+Cst+Cgs)×(Vglow−Vghigh)+C1(Clc+Cst+Cgs)×(Vghigh−Vglow)

As shown in the equation 2, if C1=Cgs, then the kick-back voltage ΔVp becomes ‘0’ theoretically. Also, even though other parasitic capacitances existing at the pixel electrode is considered, the pixel structure according to an embodiment of the present invention can minimize the kick-back voltage ΔVp. Therefore, 0V or a much lower DC voltage than a voltage Vcom of a conventional common electrode can be applied to the lower electrode of the liquid crystal, so that it is possible to decrease a dynamic range of the data line voltage.

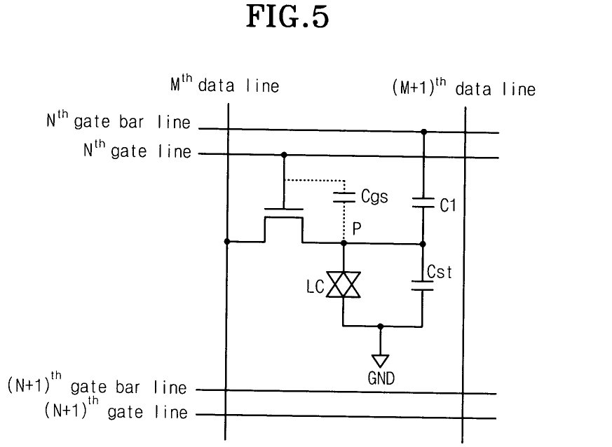

FIG. 5 is a view showing another embodiment of a pixel structure according to the prevent invention.

As shown in FIG. 5, the pixel structure according to another embodiment of the present invention includes a storage capacitor Cst connected parallel to the liquid crystal, in addition to a capacitor C1 described in FIG. 3. The storage capacitor Cst not only decreases the kick-back voltage ΔVp but also prevents the liquid crystal voltage from decreasing due to current leakage in the liquid crystal or current leakage which may be caused when the gate of a TFT is in a turn-off state, thereby increasing the voltage-holding ratio (VHR).

As described above, in the case of using a liquid crystal display having a pixel structure according to embodiments of the present invention, even if the voltage of a gate line goes down rapidly, it is possible to minimize the variation width of a pixel voltage. Therefore, as compared to the prior art, the liquid crystal display according to the present invention has advantages in that a dynamic range of data line voltage is lower, the adjustment of the common voltage Vcom is unnecessary, a display problem of 30 Hz flicker caused by the kick-back voltage ΔVp can be solved, and so forth.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A liquid crystal display comprising:
thin film transistors connected to intersections between a plurality of data lines and a plurality of gate lines;
pixel electrodes, each of which is connected to a source of each of the thin film transistors;
common electrodes opposed to the pixel electrodes;
liquid crystal injected between the pixel electrodes and the common electrodes;
a plurality of auxiliary gate lines corresponding to the gate lines; and
first capacitors, each of which is connected between the source and each of the auxiliary gate lines.

2. A liquid crystal display as claimed in claim 1, wherein a second capacitor is connected between the source and each of the common electrodes.

3. A liquid crystal display as claimed in claim 1 or claim 2, wherein the polarity of the voltage applied to the auxiliary gate line is opposite to that applied to the gate line.

4. A liquid crystal display as claimed in claim 3, wherein the first capacitor has capacitance identical to that of a parasitic capacitance between the source and gate of the thin film transistor.
